(19) United States
(12) Patent Application Publication
(10) Pub. No.: US 2011/0008676 A1
(43) Pub. Date: Jan. 13, 2011

(54) ANODE FOR LITHIUM-ION CELL AND METHOD OF MAKING THE SAME

(76) Inventors: M. Neal Golovin, Carmel, IN (US); Taison Tan, Fishers, IN (US)

Correspondence Address: ICE MILLER LLP, ONE AMERICAN SQUARE, SUITE 3100, INDIANAPOLIS, IN, 46282-0200, US

(21) Appl. No.: 12/921,025

(22) PCT Filed: Mar. 4, 2009
(86) PCT No.: PCT/US09/35989

§ 371 Date: Sep. 27, 2010

Related U.S. Application Data
(60) Provisional application No. 61/033,538, filed on Mar. 4, 2008.

(51) Int. Cl. H01M 4/485; H01M 4/13; H01M 4/62; H01M 4/131; H01B 1/02

(52) U.S. Cl. 429/217; 429/246; 429/231.1; 429/209; 252/520.21; 252/507

(57) ABSTRACT

The disclosure of the present application provides various compositions, and methods for preparing the same, which may be useful, for example, to prepare one or more anodes of the present disclosure. Such anodes may be useful, for example, to prepare one or more batteries which themselves, for example, may be useful in connection with a vehicle as referenced herein. In at least one embodiment of an anode of the present disclosure, the anode comprises lithium-based compound having the formula Li₄≦Ti_{5-y}M_{y}O_{12-z}X_{z}, wherein M comprises a dopant material selected from the group consisting of molybdenum, tungsten, zirconium, and hafnium, wherein X comprises a chalcogen selected from the group consisting of sulfur, selenium, and tellurium, wherein 0<y≦1, and wherein 0<z≧2y.

### PRIORITY

The present application related to, claims the priority benefit of, and is a U.S. national stage application of, International Patent Application Ser. No,: PCT/US2009/035989, entitled “ANODE FOR LITHIUM-ION CELL AND METHOD OF MAKING THE SAME,” filed Mar. 4, 2009, which is related to and claims the benefit of U.S. Provisional Patent Application Ser. No. 61/033,638, entitled “ANODE FOR LITHIUM ION CELL AND METHOD OF MAKING THE SAME,” filed Mar. 4, 2008, the contents of which are incorporated herein by reference in their entirety.

### BACKGROUND

Many motor vehicles, such as hybrid vehicles, use multiple propulsion systems to provide motive power. The most commonly referenced hybrid vehicles are gasoline-electric hybrid vehicles, which use gasoline (petrol) to power internal-combustion engines (ICEs), and electric batteries to power electric motors. Such hybrid vehicles recharge their batteries by capturing kinetic energy via regenerative braking. When cruising or idling, some of the output of the combustion engine is fed to a generator (merely the electric motor(s) running in generator mode), which produces electricity to supply the motive electric motor and to charge the batteries. Gasoline-electric hybrid vehicles differ from all-electric vehicles, as the latter use batteries charged by an external source (such as from a power grid), or a range extending trailer. However, nearly all hybrid vehicles still require gasoline as their sole fuel source, although other types of fuel, such as diesel fuel, ethanol, or other plant-based oils, have also seen occasional use.

Batteries and cells are important energy storage devices well known in the art. Electrical energy is produced in the battery by the chemical reaction that occurs between two dissimilar electrode plates that are immersed in an electrolyte solution. The largest demand placed on the battery occurs when it must supply current to operate a motive motor at acceleration, such as a situation when a battery is used to start a vehicle. The amperage requirements of the motive motor may be over several hundred amps. Most battery types that have a large volume (or level of current supply) require large packaging which results in large weight of the battery, and is therefore not cost effective. At the same time, such high currents are required for the very limited time, usually seconds. Therefore, so called “high-rate” batteries are required for certain applications.

A typical lithium-ion cell consists of a positive electrode (a “cathode” or a “cathode matrix”), a negative electrode (an “anode” or an “anode matrix”) and an electrolyte (a solution or a solid-state product) containing dissociated salts separated by a micro-porous membrane (a “separator”). The lithium ions transfer between the two electrodes through the electrolyte. During the charging process, lithium ions are extracted from the cathode matrix, go through the electrolyte and separator and intercalate into the anode matrix. Simultaneously, electrons are released from the cathode, go through the external circuit and are accepted by anode compounds. The reverse process occurs during the discharging process.

Metal oxides, such as lithium metal oxides, have found utility in secondary batteries as cathode and anode intercalating materials. The spinel Li₄Ti₅O₁₂ has been found to be an attractive material for electrodes (Colbow et al., J. Power Sources, 26(3-4), pp. 397-402 (1989)). In the lithium titanate spinel-type structure of Li₄Ti₅O₁₂, the formal valence of titanium is +4, which is the highest achievable oxidation state possible for titanium (Zachau-Christiansen et al., Solid State Ionics, 40-41 part 2, pp. 580-584 (1990)). This Li₄Ti₅O₁₂ material has been found to intercalate lithium ions without strain or shrinkage to the lattice (Ohzuku et al., J Electrochem Soc, 142(5), pp. 1431-1435 (1995)) making it ideal for hybrid electric vehicle (“HEV”) applications.

Theoretically, the lithium insertion reaction (intercalation) at the anode is:

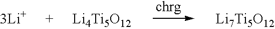

This reaction occurs at approximately 1.5V vs. metallic lithium. The titanium is reduced from the +4 state to the +3 state, with the mean oxidation state of 3.4 (60% Ti³⁺ and 40% Ti⁴⁺) when fully intercalated.

### BRIEF SUMMARY

The disclosure of the present application provides various compositions, and methods for preparing the same, which may be useful, for example, to prepare one or more anodes of the present disclosure. Such anodes may be useful, for example, to prepare one or more batteries which themselves, for example, may be useful in connection with a vehicle as referenced herein.

This disclosure of the present application relates to metal oxide compounds and methods of making the same. In at least one embodiment of the disclosure of the present application, the present disclosure relates to doped metal oxide insertion compounds for use in lithium and lithium-ion batteries.

In at least one embodiment of the disclosure of the present application, the disclosure provides a composition of an anode of spinel-type structure with a dopant material that will replace some of the transition metal, and which may also replace some oxygen in the anode, and yet will maintain the overall potential of the electrode below ˜1.7V vs. lithium. The effect is the dopant metal would be reduced instead of the primary transition metal during cycling.

In at least one embodiment of an anode of the disclosure of the present application, the anode comprises a lithium-based compound having the formula Li₄Ti_{5-y}M_{y}O₁₂, wherein M comprises a dopant material, and wherein 0<y≦1. In exemplary embodiments, the dopant material may comprise molybdenum (Mo), tungsten (W), zirconium (Zr), or hafnium (Hf).

In at least one embodiment of an anode of the disclosure of the present application, the anode comprises a lithium-based compound having the formula Li₄Ti_{5-y}M_{y}O_{12-z}X_{z}, wherein M comprises a dopant material, wherein X comprises a chalcogen, wherein 0<y≦1, and wherein 0<z≦2y. Any or all of the various features and/or limitations disclosed herein regarding embodiments of an anode of the present disclosure may be applicable to other embodiments of anodes disclosed herein. In various embodiments, the chalcogen may comprise sulfur (S), selenium (Se) or tellurium (Te).

In at least one embodiment of a battery of the disclosure of the present application, the battery comprises an anode, a cathode, and an electrolyte, wherein the anode comprises a lithium-based compound. In an exemplary embodiment, the lithium-based compound has the formula Li₄Ti_{5-y}M_{y}O₁₂, wherein M comprises a dopant material, and wherein 0<y≦1. In another embodiment, the lithium-based compound has the formula Li₄Ti_{5-y}M_{y}O_{12-z}X_{z}, wherein M comprises a dopant material, wherein X comprises a chalcogen, wherein 0<y≦1, and wherein 0<z≦2y.

In at least one embodiment of a method for preparing a lithium-based composition of the present disclosure, the method comprises the step of introducing amounts of a first material, a second material, and a third material to a vessel, wherein the first material comprises lithium, wherein the second material comprises titanium and oxygen, and wherein the third material comprises a dopant material and a chalcogen. Such a method further comprises the steps of grinding the first material, the second material, and the third material within the vessel, and heating the ground vessel contents for a period of time at an elevated temperature to create the lithium-based composition.

In at least one embodiment of a method for preparing at least a portion of an anode of the disclosure of the present application, the method comprises the steps of preparing a lithium-based composition of the disclosure of the present application, introducing the lithium-based composition, a conductive medium, a graphite source, and a binder to a receptacle, mixing the contents of the receptacle to form a mixture, and placing the mixture on a metallic substrate to form at least a portion of an anode.

### DETAILED DESCRIPTION

The disclosure of the present application provides various compositions, and methods for preparing the same, which may be useful, for example, to prepare one or more anodes of the present disclosure. Such anodes may be useful, for example, to prepare one or more batteries which themselves, for example, may be useful in connection with a vehicle as referenced herein.

In at least one embodiment of an anode of the disclosure of the present application, the anode comprises a lithium-based compound having the formula Li₄Ti_{5-y}M_{y}O₁₂, wherein M comprises a dopant material, and wherein 0<y≦1. In exemplary embodiments, the dopant material may comprise molybdenum (Mo), tungsten (W), zirconium (Zr), or hafnium (Hf). In at least one embodiment, y=0.1, so that the lithium-based compound has the formula Li₄Ti_{4.9}M_{0.1}O₁₂. In an exemplary embodiment, the dopant material comprises molybdenum, so that the lithium-based compound has the formula Li₄Ti_{5-y}Mo_{y}O₁₂. In at least one embodiment, the lithium-based compound has the formula Li₄Ti_{4.9}Mo_{0.1}O₁₂.

In at least one embodiment of an anode of the disclosure of the present application, the anode comprises a lithium-based compound having the formula Li₄Ti_{5-y}M_{y}O_{12-z}X_{z}, wherein M comprises a dopant material, wherein X comprises a chalcogen, wherein 0<y≦1, and wherein 0<z≦2y. Any or all of the various features and/or limitations disclosed herein regarding embodiments of an anode of the present disclosure may be applicable to other embodiments of anodes disclosed herein. In various embodiments, the chalcogen may comprise sulfur (S), selenium (Se) or tellurium (Te). In at least one embodiment, the lithium-based compound has the formula Li₄Ti_{5-y}Mo_{y}O_{12-z}X_{z}. In another embodiment, z=0.2, so that the lithium-based compound has the formula Li₄Ti_{4.9}M_{0.1}O_{11.8}X_{0.2}. In an exemplary embodiment, the dopant material comprises molybdenum, the chalcogen comprises sulfur, and z=0.2, so that the lithium-based compound has the formula Li₄Ti_{4.9}Mo_{0.1}O_{11.8}S_{0.2}.

In at least one embodiment of an anode of the disclosure of the present application, said anode comprises at least a portion of a battery. Such a battery may comprise a lithium-ion cell or any other battery wherein such an anode is useful therein. In at least one embodiment, the battery is rechargeable. Any or all of the various features and/or limitations disclosed herein regarding embodiments of an anode, or the various anodes themselves, may be useful in connection with any or all of the various batteries disclosed herein.

In an exemplary embodiment of a battery comprising an anode of the disclosure of the present application, the battery comprises a cathode, a separator plate positioned between the anode and the cathode, and an electrolyte, wherein during a charging and discharging battery cycle, at least a portion of the dopant material would be reduced prior to a reduction of titanium. In another embodiment, the overall potential is below approximately 1.7V versus lithium.

In at least one exemplary embodiment of a battery of the present disclosure, the anode further comprises graphite, and may further comprise a binder effective to bind the lithium-based compound to the graphite. In an exemplary embodiment, the binder comprises polyvinylidine fluoride (PVDF) and N-methyl pyrolinidone (NMP). In another embodiment, the lithium-based compound bound to the graphite may positioned on a metallic substrate, such as copper foil.

In at least one embodiment of a battery of the disclosure of the present application, the battery comprises an anode, a cathode, and an electrolyte, wherein the anode comprises a lithium-based compound. In an exemplary embodiment, the lithium-based compound has the formula Li₄Ti_{5-y}M_{y}O₁₂, wherein M comprises a dopant material selected from the group consisting of molybdenum, tungsten, zirconium, and hafnium, and wherein 0<y≦1. In another embodiment, M comprises Mo, so that the lithium-based compound of the anode of the battery has the formula Li₄Ti_{5-y}Mo_{y}O₁₂. In at least one embodiment, M comprises Mo, and y=0.1, so that the lithium-based compound of the anode of the battery has the formula Li₄Ti_{4.9}Mo_{0.1}O₁₂.

In at least one exemplary embodiment of a battery of the disclosure of the present application, the lithium-based compound of the anode of the battery has the formula Li₄Ti_{5-y}M_{y}O_{12-z}X_{z}, wherein M comprises a dopant material selected from the group consisting of molybdenum, tungsten, zirconium, and hafnium, wherein X comprises a chalcogen, wherein 0<y≦1, and wherein 0<z≦2y. In various embodiments, the chalcogen may comprise sulfur, selenium or tellurium. In at least one embodiment, the lithium-based compound of the anode of the battery has the formula Li₄Ti_{5-y}Mo_{y}O_{12-z}X_{z}. In another embodiment, z=0.2, so that the lithium-based compound of the anode of the battery has the formula Li₄Ti_{4.9}M_{0.1}O_{11.8}X_{0.2}. In an exemplary embodiment, the dopant material comprises molybdenum, the chalcogen comprises sulfur, and z=0.2, so that the lithium-based compound of the anode of the battery has the formula Li₄Ti_{4.9}Mo_{0.1}O_{11.8}S_{0.2}.

In at least one embodiment of a battery of the disclosure of the present application, the battery comprises an anode, a cathode, and an electrolyte, wherein the anode comprises a spinel and at least one dopant selected from the group consisting of molybdenum, tungsten, zirconium, and hafnium. In an exemplary embodiment, the spinel comprises at least one lithium metal oxide. In at least one embodiment, the lithium metal oxide comprises Li₄Ti₅O₁₂.

Any or all of the various features and/or limitations disclosed herein regarding embodiments of a battery or portion of a battery, or the various batteries or portions of the various batteries themselves, may be useful in connection with any or all of the various batteries disclosed herein. For example, an exemplary embodiment of an anode referenced herein may be used within an exemplary embodiment of a battery disclosed herein, although the specific anode embodiment and the specific battery embodiment was not specifically referenced in connection with one another.

In addition, the various compounds referenced herein in connection with one or more anodes are not intended to be solely useful as anode compounds. For example, and exemplary compound of the present disclosure may have the formula Li₄Ti_{5-y}M_{y}O₁₂, wherein M comprises a dopant material selected from the group consisting of molybdenum, tungsten, zirconium, and hafnium, and wherein 0<y≦1, without such a compound having the sole use of being used in connection with the preparation of an anode of the present disclosure. Such compounds may have one or more other uses, and as such, any reference to a compound within the disclosure of the present application is not intended to be, and should not be treated as, having, a sole utility in connection with anodes.

The various embodiments of compounds, anodes, and batteries of the disclosure of the present application may be useful in connection with one or more vehicles as referenced herein. For example, and in at least one embodiment, a vehicle of the present disclosure may comprise a battery of the present disclosure, wherein the battery comprises an anode, a cathode, and an electrolyte, wherein the anode comprises a lithium-based compound having the formula Li₄Ti_{5-y}M_{y}O₁₂, wherein M comprises a dopant material selected from the group consisting of molybdenum, tungsten, zirconium, and hafnium, and wherein 0<y≦1. In another embodiment, an exemplary vehicle of the disclosure of the present application comprises a battery comprising an anode comprising a lithium-based compound having the formula Li₄Ti_{5-y}M_{y}O_{12-z}X_{z}, wherein M comprises a dopant material selected from the group consisting of molybdenum, tungsten, zirconium, and hafnium, wherein X comprises a chalcogen selected from the group consisting of sulfur, selenium and tellurium, wherein 0<y≦1, and wherein 0<z≦2y.

At least one advantage of the disclosure of the present application is to provide materials that can also be used as dopants when mixed with anodic lithium metal oxide that will not reduce the overall cell potential. Several dopants, or combinations of dopants, may be selected to replace some of the transition metal in a LiM_{y}O_{z} system as disclosed herein, but still keep the overall potential below 1.7V. As such, the disclosure of the present application is not limited to any one specific dopant. For example, and in a Li₄Ti₅O₁₂ anode system of the present disclosure, the titanium can be replaced by molybdenum, tungsten, zirconium, or hafnium (Hf), and still maintain a potential below 1.7V. For such a system, the formula for the active anode material would be Li₄Ti_{5-y}M_{y}O₁₂, wherein 0<y≦1, and wherein M=Mo, W, Zr of Hf.

The disclosure of the present application contains embodiments, in addition to replacing the primary transition metal, which replace some of the oxygen with another dopant material as well, such as with sulfur (S), selenium (Se) or tellurium (Te). A general objective remains the same in that the overall potential of the electrode would remain below 1.7V, Molybdenum disulfide (MoS₂), for example, as an active material has a potential of ˜1.6V vs. Li. Employing the sulfur in place of oxygen will help reduce the material voltage.

Hence, a new chemical formula in accordance with the foregoing is Li₄Ti_{5-y}M_{y}O_{12-z}S_{z}, wherein 0<y≦1, wherein 0<z≦2y, and wherein M=Mo, W, Zr, or Hf. A more generalized formula in accordance with the foregoing is Li₄Ti_{5-y}M_{y}O_{12-z}X_{z}, wherein 0<y≦1, wherein 0<z≦2y, wherein M=Mo, W, Zr, or Hf, and wherein X=S, Se, or Te. In at least one embodiment of such a composition, M=Mo, X=S, y=0.1, and z=0.2, so that the formula comprises Li₄Ti_{4.9}Mo_{0.1}O_{11.8}S_{0.2}.

An exemplary rechargeable lithium-ion battery whose anode comprises such an electrode material layer has significant advantages such that the magnitude of the volume expansion of the anode when lithium is inserted upon charging and the magnitude of the volume shrinkage of the anode when said lithium is released upon discharging are slight. In addition, the performance of such an anode is more difficult to deteriorate even when charge-and-discharge cycle is repeated over a long period of time, providing such a rechargeable lithium-ion battery with an improved charge-and-discharge cycle life.

An exemplary lithium-based compound of the present disclosure may be prepared as follows. In at least one embodiment, a method for preparing a lithium-based compound comprises the steps of introducing amounts of a first material, a second material, and a third material to a vessel, grinding those ingredients, and heating those ingredients for a period of time at an elevated temperature to create the lithium-based composition. In an exemplary embodiment, the first material comprises lithium, the second material comprises titanium and oxygen, and the third material comprises a dopant material and a chalcogen. Once the ingredients have combined at an elevated temperature, those ingredients may be allowed to cool and/or may be cooled (using a refrigerator, freezer, cold water bath, etc.) and optionally ground, if desired, to produce a room-temperature ground lithium-based compound.

In an exemplary embodiment, a fourth material, namely gas, may be introduced to the vessel prior to and/or during the heating step. In at lease one example, the gas would be introduced to the vessel by providing a flow of the gas to the vessel during the heating step. Such a gas may comprise air, oxygen gas, or any other suitable gas containing oxygen.

In at least one embodiment, the dopant material would comprise molybdenum, tungsten, zirconium, or hafnium, and the chalcogen would comprise sulfur, selenium and tellurium. In various additional examples, one or more of the following ingredients may be used: lithium carbonate as the first material, titanium dioxide or anatase titanium dioxide as the second material, and/or molybdenum disulfide as the third material.

The ingredients may be ground in a vessel using any number of known grinding methods, including the use of a mortar and pestle and/or a ball mill. Such grinding methods illustrated herein are not intended to limit the scope of the present disclosure as other suitable grinding methods may be used. In at least one embodiment, the method would comprise grinding the ingredients in a first vessel, such as a mortar, and heating the ingredients in a second vessel, such as a platinum crucible. The heating step, in at least one method of preparing an exemplary lithium-based compound, would last approximately 24 hours at an elevated temperature is approximately 900° C. After an exemplary lithium-based compound is prepared, it may be stored in a light-proof plastic container, for example, or it may be used to prepare an anode as referenced herein.

In at least one method for preparing a lithium-based composition, the desired lithium-based composition comprises a compound of the formula Li₄Ti_{5-y}M_{y}O_{12-z}X_{z}, wherein M comprises the dopant material, wherein X comprises the chalcogen, wherein 0<y≦1, and wherein 0<z≦2y. In an exemplary embodiment, the dopant material may comprise consisting of molybdenum, tungsten, zirconium, or hafnium, and the chalcogen may comprise sulfur, selenium and tellurium. In at least one embodiment, y=0.1 and z=0.2. In another embodiment, the dopant material comprises molybdenum, the chalcogen comprises sulfur, and z=0.2.

At least one method of preparing an exemplary lithium-based compound, namely Li₄Ti_{4.9}Mo_{0.1}O_{11.8}S_{0.2}, is as follows. In at least this example, the starting materials for the preparation of Li₄Ti_{4.9}Mo_{0.1}O_{11.8}S_{0.2} are lithium carbonate (Li₂CO₃) as the Li source, anatase titanium dioxide (TiO₂) as the titanium and oxygen source, molybdenum disulfide (MoS₂) as the molybdenum (dopant material) and sulfur (chalcogen) source, and dry air as the rest of the oxygen.

In an exemplary batch, 26.62 g of Li₂CO₃, 70.50 g of TiO₂, and 2.88 g of MoS₂ were combined and ground, first by hand in a mortar and pestal. A second grinding in a ball mill was performed to facilitate intimate mixing of the different materials. The ground mixture was then placed in a platinum crucible and fired in a tube furnace at 900° C., under a dry air flow, for 24 hr. The mixture was cooled to room temperature and lightly ground to break up large aggregated clumps of material. The ground material (the resulting lithium-based composition) was then weighed and stored in a light proof plastic container. An expected yield of Li₄Ti_{4.9}Mo_{0.1}O_{11.8}S_{0.2} for such an exemplary preparation is 84.14 g.

An exemplary anode of the present disclosure, or at least a portion of such an anode, may be prepared as follows. In at least one embodiment, a method for preparing at least a portion of an anode, the method comprising the steps of preparing a lithium-based composition of the disclosure of the present application, introducing the lithium-based composition, a conductive medium, a graphite source, and a polymer/binder to a receptacle, mixing those items together, and placing the mixture on a metallic substrate to form at least a portion of an anode. Any or all of the various features, steps, and/or limitations disclosed herein regarding the preparation of a lithium-based composition of the present disclosure may be applicable to the preparation of a lithium-based composition useful to prepare an anode or a portion thereof.

In at least one exemplary embodiment, the conductive medium may comprise acetylene black (Denka black). In various embodiments, the polymer/binder may comprise polyvinylidine fluoride (PVDF) and N-methyl pyrolinidone (NMP), and/or the graphite source may comprise SGF6 graphite, also known as Superior Graphite. When mixing the ingredients, small aliquots of the polymer/binder may be added over time to the conductive medium, the graphite source, and the lithium-based compound. Mixing may be stopped when the mixture reaches a desired viscosity. In a least one embodiment, the mixing step is completed when the mixture reaches a viscosity between about 5100 cP and about 5300 cP as indicated by a viscometer operating at approximately 20 RPM.

Once mixed to a desired mixture consistency, said mixture may be positioned on a metallic substrate, such as, for example, copper foil, and dried to prepare at least a portion of an anode. The disclosure of the present application is not intended to be limited to any specific metallic substrate, as, for example, one or more other metallic substrates, such as an aluminum foil, may be suitable for the preparation of an exemplary anode, or part of an anode, of the present disclosure. In an exemplary embodiment, the step of placing the mixture on a metallic substrate comprises feeding the mixture through a fixed-gap slot dye onto the metallic substrate, wherein the metallic substrate is rotated about a spool. In at least one method, the fixed-gap is fixed at 5 μm.

After the mixture is placed on the metallic substrate to form at least a portion of an anode, an exemplary method of preparing at least a portion of an anode may further comprise the step of drying the at least a portion of an anode for a period of time at an elevated temperature under a vacuum. In at least one method, the period of time is approximately 15 hours, and wherein the elevated temperature is approximately 120° C. Once heated, combination may be cooled under a vacuum, and if desired, it may also be stored within a laminated foil pouch.

In an exemplary anode/electrode preparation, the anode(s) based on Li₄Ti_{4.9}Mo_{0.1}O_{11.8}S_{0.2} are prepared for a lithium-ion cell electrode. Into a planetary paddle mixer, 42.2 g of Li₄Ti_{4.9}Mo_{0.1}O_{11.8}S_{0.2}, 2 g of Denka black (acetylene black, a conductive medium) and 2 g of SGF6 graphite (Superior Graphite) were combined. 33.73 g of 13% PVDF solution in N-methyl pyrolinidone (NMP) (binder) was added to the mixture. Small aliquots of NMP were added during mixing, and the mixture was occasionally checked for its viscosity using a Brookfield DV-III viscometer. Mixing was completed when the viscosity reached a value between 5100 and 5300 cP at 20 RPM.

A roll of 10 μm thick copper foil was mounted on a source spool and wound through a coating head made up of a driver roller and a fixed gap slot dye. The gap was fixed to 5 μm, and the mixture/slurry as prepared above was is fed through the dye and onto the copper foil. The NMP was removed by drying in a forced air convection oven in line on the coater. The coated copper foil was transferred to the dry room, and dried at 120° C. for 15 hr under a vacuum. The dried electrode stock was allowed to cool to room temperature under vacuum, and was then sealed in a laminated foil pouch to protect the coating until used.

While various embodiments of compositions, anodes, and batteries been described in considerable detail herein, the embodiments are merely offered by way of non-limiting examples of the disclosure described herein. Many variations and modifications of the embodiments described herein will be apparent to one of ordinary skill in the art in light of this disclosure. It will therefore be understood by those skilled in the art that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps disclosed herein should not be construed as limitations of the present disclosure. In addition, disclosure directed to a method and/or process should not be limited to the performance of their steps in the order written, and one skilled in the art can readily appreciate that the sequences may be varied and still remain within the spirit and scope of the present disclosure.

It is therefore intended that the disclosure will include all modifications and changes apparent to those of ordinary skill in the art based on this disclosure.

We claim:

1. An anode comprising a lithium-based compound having the formula:
Li₄Ti_{5-y}M_{y}O₁₂,
wherein M comprises a dopant material selected from the group consisting of molybdenum, tungsten, zirconium, and hafnium; and
wherein 0<y≦1.

2. The anode of claim 1, wherein the dopant material comprises molybdenum, and wherein y=0.1.

3-5. (canceled)

6. The anode of claim 1, wherein y=0.1.

7. (canceled)

8. The anode of claim 1, wherein said anode comprises at least a portion of a rechargeable battery.

9. The anode of claim 8, wherein the battery comprises a lithium-ion cell.

10. (canceled)

11. The anode of claim 8, wherein the battery further comprises a cathode, a separator plate positioned between the anode and the cathode, and an electrolyte.

12. The anode of claim 8, wherein during a charging and discharging battery cycle, at least a portion of the dopant material would be reduced prior to a reduction of titanium.

13. (canceled)

14. The anode of claim 1, wherein an overall potential is below approximately 1.7V versus lithium.

15. (canceled)

16. The anode of claim 1, wherein said anode further comprises graphite and a binder effective to bind the lithium-based compound to the graphite.

17. The anode of claim 16, wherein the binder comprises polyvinylidine fluoride and N-methyl pyrolinidone.

18. The anode of claim 16, wherein the lithium-based compound bound to the graphite is positioned on a metallic substrate.

19. The anode of claim 18, wherein the metallic substrate comprises copper foil.

20-22. (canceled)

23. A battery, comprising:
an anode;
a cathode; and
an electrolyte;
wherein the anode comprises a lithium-based compound having the formula:
Li₄Ti_{5-y}M_{y}O₁₂,
wherein M comprises a dopant material selected from the group consisting of molybdenum, tungsten, zirconium, and hafnium; and
wherein 0<y≦1.

24. The battery of claim 23, wherein the dopant material comprises molybdenum, and wherein y=0.1.

25-27. (canceled)

28. The battery of claim 23, wherein y=0.1.

29-112. (canceled)

113. A compound of the formula:
Li₄Ti_{5-y}M_{y}O₁₂,
wherein M comprises a dopant material selected from the group consisting of molybdenum, tungsten, zirconium, and hafnium; and
wherein 0<y≦1.

114. The compound of claim 113, wherein the dopant material comprises molybdenum, and wherein y=0.1.

115-117. (canceled)

118. The compound of claim 113, wherein y=0.1.

119. (canceled)

120. The compound of claim 113, wherein said compound is an active material of an anode of a lithium-ion battery.

121-201. (canceled)

202. A battery, comprising:
an anode;
a cathode; and
an electrolyte;
wherein the anode comprises a spinel and at least one dopant selected from the group consisting of molybdenum, tungsten, zirconium, and hafnium.

203. The battery of claim 202, wherein the spinel comprises at least one lithium metal oxide.

204. The battery of claim 202, wherein the at least one lithium metal oxide comprises Li₄Ti₅O₁₂.

205. A vehicle, comprising:
a battery, comprising:
an anode;
a cathode; and
an electrolyte;
wherein the anode comprises a lithium-based compound having the formula:
Li₄Ti_{5-y}M_{y}O₁₂,
wherein M comprises a dopant material selected from the group consisting of molybdenum, tungsten, zirconium, and hafnium; and
wherein 0<y≦1.

206. (canceled)
